(19) United States
(12) Patent Application Publication
(10) Pub. No.: US 2024/0141675 A1
(43) Pub. Date: May 2, 2024

(54) SYSTEM AND METHOD OF TEMPORARY PRIVACY SHELTERING AFFIXED TO SPORT UTILITY VEHICLE HATCHBACK

(71) Applicant: Oanh Nguyen, Sycamore, IL (US)

(72) Inventor: Oanh Nguyen, Sycamore, IL (US)

(21) Appl. No.: 17/979,751

(22) Filed: Nov. 2, 2022

(51) Int. Cl. E04H 15/06

(52) U.S. Cl. CPC E04H 15/06; E04H 15/64

(57) ABSTRACT

A system for providing a temporary sheltered space in a public area is provided. The system comprises a contiguous first panel and second panel of fabric positioned vertically and attached to each other at a single point proximate an upper edge of the attached panels, a sport utility vehicle that supports the panels via attachment of far upper left and far upper right corners of the panels to upper rear body areas of the vehicle, a hatchback of the vehicle holding an upper edge of the attached panels between the corners at a bottom end of the hatch. During opening, the hatchback raises the edge of the contiguous panels at the bottom end of the hatchback while the upper corners of the attached panels remain attached. Based on raising the edge of the panels at the bottom edge of the hatchback, a temporary sheltered space is created.

### CROSS REFERENCE TO RELATED APPLICATIONS

None

### FIELD OF THE DISCLOSURE

The present disclosure is in the field of leisure-time outdoor equipment. More particularly, the present disclosure provides systems and methods of a temporary lightweight shelter for changing clothes magnetically attached to a sport utility vehicle or other vehicle.

### BACKGROUND

Persons visiting public recreation environments such as parks, beaches, and camping areas occasionally need to change clothes. They may not have access to locker rooms, bathhouses, or other areas providing privacy for various reasons. Locker rooms and bathrooms may not exist at all. At public parks, such facilities are frequently dirty and dangerous or simply locked. A person may only need privacy for a short time, for example several minutes, to remove a wet bathing suit and change into dry clothes for a trip back home.

Many beaches, for example, do not provide facilities for non-residents or non-members if the beach or green area is private. Such club-like and exclusive areas may be unwelcoming to visitors who are ordinary members of the general public. Such areas may also have strict laws against nudity that are aggressively enforced by local police or private security. A visitor to a beach, which in most cases is public property but heavily obstructed by private property owners, does not have a dignified way to simply remove a wet bathing suit and put on dry clothes.

The situation is similar for visitors to large outdoor concerts, rallies, and sporting events which do not provide proper facilities such that visitors must change clothes in open parking areas. A visitor cannot change clothes in a dignified manner with hordes of strangers passing by in outdoor parking fields.

### BRIEF DESCRIPTION OF THE FIGURES

FIG. 1 is a diagram of a system of temporary privacy sheltering affixed to sport utility hatchback in accordance with an embodiment of the present disclosure.

FIG. 2 is a diagram of a system of temporary privacy sheltering affixed to sport utility hatchback in accordance with an embodiment of the present disclosure.

FIG. 3 is a diagram of a system of temporary privacy sheltering affixed to sport utility hatchback in accordance with an embodiment of the present disclosure.

FIG. 4 is a diagram of a system of temporary privacy sheltering affixed to sport utility hatchback in accordance with an embodiment of the present disclosure.

FIG. 5 is an image of a system of temporary privacy sheltering affixed to sport utility hatchback in accordance with an embodiment of the present disclosure.

FIG. 6 is an image of a system of temporary privacy sheltering affixed to sport utility hatchback in accordance with an embodiment of the present disclosure.

FIG. 7 is an image of a system of temporary privacy sheltering affixed to sport utility hatchback in accordance with an embodiment of the present disclosure.

### DETAILED DESCRIPTION

Systems and methods described herein provide a lightweight sheet of fabric that magnetically attaches to a rear area of a sport utility vehicle (SUV) with an automatic hatchback. When the hatchback is opened, the sheet is lifted and spread to create a sheltered space for a user to have temporary privacy. Upper corners of the rectangular or square sheet are magnetically attached to upper rear corners of the body of the vehicle.

The center of the horizontal upper edge of the sheet, sagging down between the two upper corners while the hatchback is closed, is magnetically attached to the lower edge of the hatchback door. The opening of the hatchback door raises the center of the upper edge of the sheet to a point above the heads of most users. At the same time the aforementioned upper corners of the sheet remain attached to the upper rear corners of the vehicle.

Other magnets may be used to attach further areas of the sheets to the body of the vehicle, for example along vertical side edges of the sheets that would be attached below the magnets holding the corners in place above near the roof of the vehicle. The persistent attachment of the corners to the vehicle body combined with the raising of the middle area of the upper edge of the sheet between the corners has the effect of creating a temporary tentlike structure that may be useful for changing clothes while at a beach, for example.

The single sheet of fabric may be provided as two panels that are side by side and attach to each other at a top area of the two panels very close to where the top area magnetically attaches to the bottom of the hatchback door. Because the two panels are otherwise not attached, the opening between the two panels, once the hatchback door has been raised, effectively provides a flaplike entryway for the user to access and exit the temporary sheltered space. Magnets and/or other attachment devices such as snaps or Velcro along both sides of the flapped entryway may keep the entryway loosely closed and the user's privacy protected. In addition, small weights may be situated at lower ends of the sheets to reduce movement of the sheets caused by wind or passing vehicles.

It bears noting that the sheet does not lay atop the hatchback when the hatchback is opened. Edges of the sheet are lifted and held by the hatchback with the sheet handing from the edge or end of the hatchback after the hatchback has been opened.

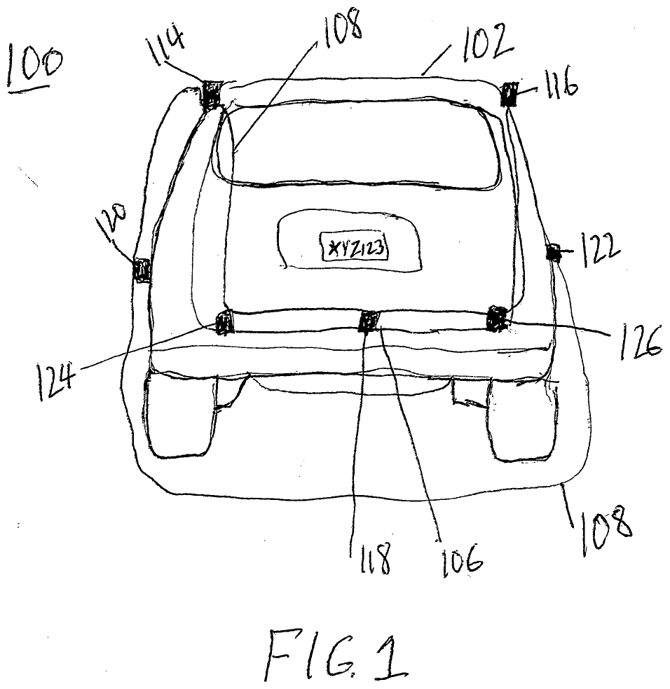

Turning to the figures, FIG. 1 is a diagram of a rear of an SUV with sheets attached by magnets. A system 100 of temporary privacy shelters in public settings is provided. The system 100 includes an SUV 102, a hatchback 104, and a hatchback center bottom end 106. The system 100 also comprises a sheet 108 of subcomponents lefthand panel 110 and a righthand panel 112.

The sheet 108 is hand drawn about the SUV 102. The lefthand panel 110 and a righthand panel 112 are not clearly visible in FIG. 1.

The system 100 also comprises left corner magnet 114 and right corner magnet 116 and hatchback center bottom end magnet 118. The left corner magnet 114 and the right corner magnet 116 hold upper left and upper right corners of the sheet 108 in place.

The sheet 108 is sufficiently wide such that when the magnets 114, 116 are in place and holding the corners of the sheet 108 in place and the hatchback 104 is closed, the horizontal upper edge of the sheet 108 sags down low enough to reach the hatchback center bottom end 106 where the hatchback center bottom end magnet 118 affixes the midpoint of the horizontal upper edge of the sheet 108 to the hatchback center bottom end 106.

The system 100 also comprises upper edge magnets 124, 126 that are to the left and right of the hatchback center bottom end magnet 118 along the bottom or lower edge of the hatchback 104. All three of the hatchback center bottom end magnet 118 and the upper edge magnets 124, 126 along with the upper edge of the sheet 108 are lifted when the user opens the hatchback 104.

The middle area the horizontal upper edge of the sheet 108 holds fast to the lower edge of the hatchback 104 by the magnets 118, 124, 126 and is raised high above the user's head. Meanwhile, the magnets 114, 116 remain in place and continue to hold the corners of the sheet 108 to upper corners of the body of the SUV 102. This action has the effect of creating a temporary shelter with the raised door of the hatchback 104 as roof and the raised sheet 108 forming a left, front, and right temporary walls of the temporary shelter.

As noted, the sheet 108 is comprised of two panels 110, 112 attached at a topmost area at or near the hatchback center bottom end 106. The previously described entryway is the open area of the flaplike area. The flaps of the entryway may be closed by magnets snaps, Velcro, or other method.

Sides, i.e., vertical edges of the sheet 108, may be affixed to the body of the SUV 102 by side body magnets 120, 122 that further hold the sheet 108 in place once the hatchback 104 is raised. As noted, the upper edge magnets 124, 126 are positioned to the left and to the right of the hatchback center bottom end magnet 118 along the bottom or outer edge of the hatchback 104 to hold the sheet 108 steady as the hatchback 104 is raised.

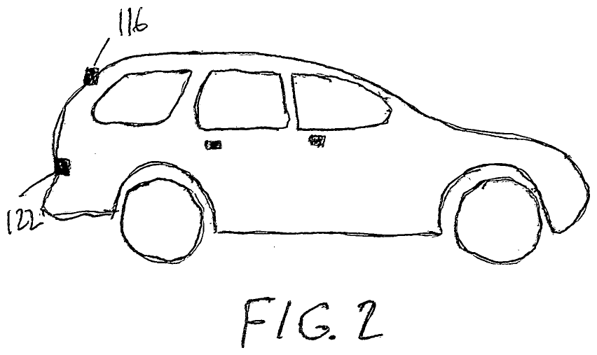

FIG. 2 is a side view of the SUV 102. The sheet 108 is not shown. The right corner magnet 116 and one of the side body magnets 122 is shown.

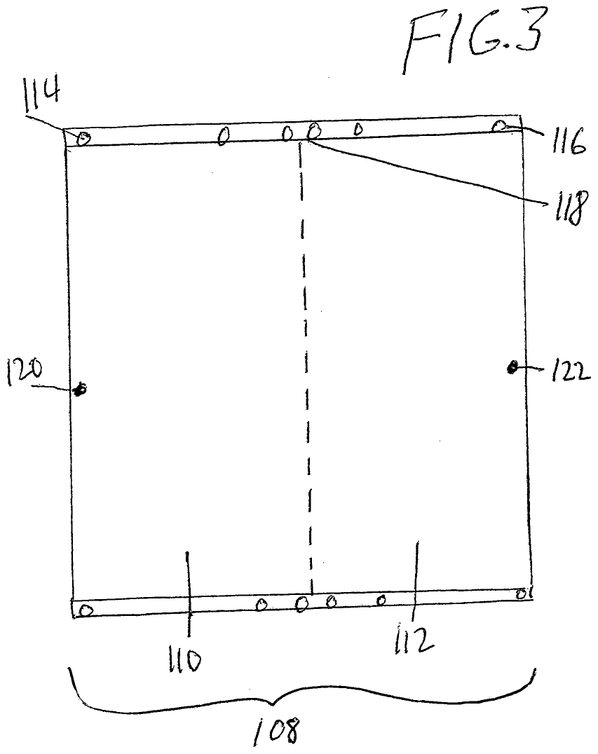

FIG. 3 is a view of the sheet 108 that comprises lefthand panel 110 and a righthand panel 112. Also shown is the hatchback center bottom end magnet 118 and the upper edge magnets 124, 126 that are to the left and right of the hatchback center bottom end magnet 118 along the bottom or lower edge of the hatchback 104. All three of the hatchback center bottom end magnet 118 and the upper edge magnets 124, 126 along with the upper edge of the sheet 108 are lifted when the user opens the hatchback 104.

The dotted line down the middle represents the entryway area between the two panels 110, 112 which are joined only at or near the top at the hatchback center bottom end magnet 118. Side body magnets 120, 122 are also shown which hold the vertical edges of the sheet 108 to the body of the SUV 102 when the hatchback 104 is opened. The small circles at the bottom of the sheet 108 represent weights to stabilize the sheet in wind. Magnets are also in place along the two interior edges of the panel 110, 112 that comprise doors of the entryway. The magnets would help keep the doors of the entryway closed.

The sheet 108 may be made of nylon or similar fabric. In an embodiment, the sheet 108 may be fourteen feet wide and seven feet in height. The fourteen-foot or similar width allows attachment of corners of the sheet 108 to upper rear corners of the SUV 102 as well as complete wrapping of the upper edge of the sheet around the full circumference of the hatchback 104. The wrapping includes full wrapping around the bottom or far end of the hatchback 104 where the magnets 118, 124, 126 hold the sheet 108 to the hatchback center bottom end 106 as well as the corners of the hatchback. This process of holding by the three magnets 118, 124, 126 of the sheet 108 to the hatchback allows the structure taught here to take place when the hatchback 104 is opened and the sheet is raised to form the aforementioned three sides or walls of the shelter.

In another embodiment for a similar but smaller structure that does not involve the hatchback 104, a temporary shelter for changing clothes near a passenger door of the SUV 102 is provided. A smaller sheet similar to the sheet 108 of the system 100 (but not involving panels) may be provided to cover an open area of a passenger door. In this embodiment, one upper corner of a smaller sheet may be attached via suction cup to a top area of a first window of a first door of a vehicle. The other upper corner of the sheet may be attached via suction cup to a top area of a second window of a second door immediately behind the first door.

With both doors closed, the sheet should loosely hang from the two suction cups from the first window and the second window. When ready, a user seated in the vehicle seat next to the first door would open the first door. This causes the sheet to pull tight and a private sheltered area to form by the first door being open and the sheet being pulled tight in the opening of the first door. The sheet remains attached to both doors.

As with the embodiment described in detail above, there may be magnets along the vertical sides of the sheet. These magnets may attach the sheet to the doors below the windows to keep the sheet from moving. Similarly, there may also be weights along the bottom of the sheet to hold the sheet in place. The sheet used for this alternative embodiment may be of various lengths and widths depending on the type of vehicle involved.

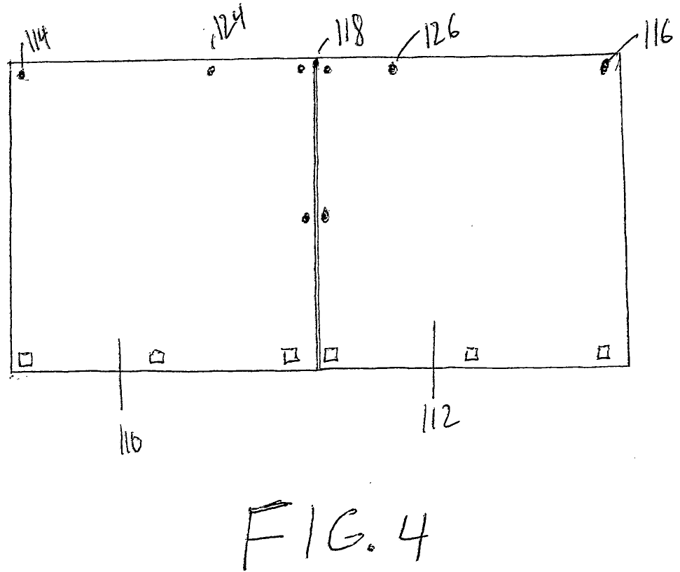

FIG. 4 is a drawing of a system of temporary privacy sheltering affixed to sport utility hatchback in accordance with an embodiment of the present disclosure. FIG. 4 is a drawing of the sheet 108 with its two panels 110, 112 labeled. The magnets 118, 124, 126 are also labeled in their position across the far end of the hatchback 104. In FIG. 4, magnets may be indicated by small darkened circles and weights may be indicated by small squares.

It should be noted that the sheet 108 in FIG. 4 is shown in its 14-foot-wide entirety. The portion of the sheet 108 at the end of the hatchback 104 is only between the two upper edge magnets 124, 126.

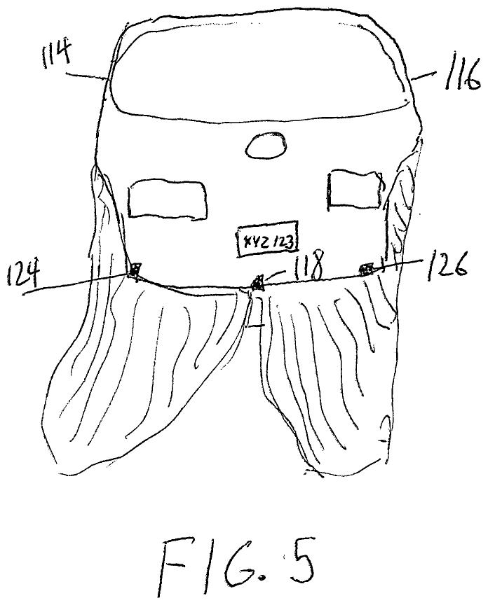

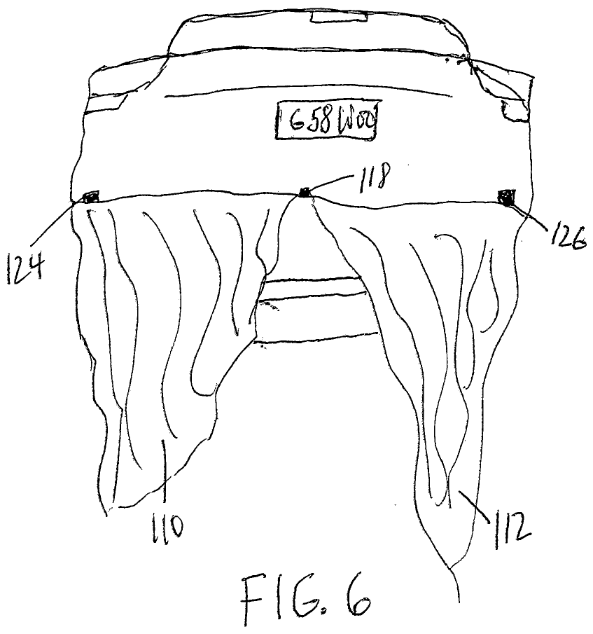

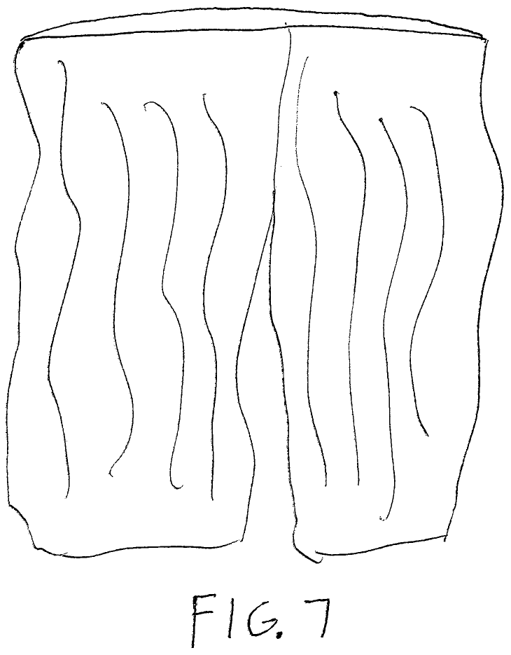

FIG. 5, FIG. 6, and FIG. 7 are views of the SUV 102 with the sheet attached before, during, and after opening, respectively. In FIG. 5, the aforementioned sagging of the sheet 108 is visible. The 14-foot-wide sheet extends from one corner at the magnet 112 near the upper corner of the SUV 102, down to the three magnets 124, 118, 126 along the bottom edge of the hatchback door, and back up to the second corner magnet 116.

In FIG. 6, the SUV 102 is in the process of raising the sheet 108. The three magnets 124, 118, 126 along the bottom edge of the hatchback 104 are prominently shown as the hatchback 104 is at about a halfway point in lifting the sheet 104 to create the sheltered space. The two corner magnets 114, 116, which are not shown in FIG. 6, remain in place and continue to hold the far left and right corners of the sheet 108 to the body of the SUV 102. FIG. 6 also depicts the two panels 110, 112 of the sheet 108 with the space or entryway between the panels 110, 112. The edged of the panels 110, 112 that form the entryway would have magnet, snaps, or Velcro allowing a user to close the entryway and have privacy.

FIG. 7 depicts the sheet 198 in fully raised state to create the shelter. The upper edge of the sheet 108, which may be 14 feet in length from the left corner magnet 114 to the right corner magnet 116, is fully around the three sides of the hatchback 104. All five magnets, including the corner magnets 114, 116 and the three magnets 124, 118, 126 along the front edge of the hatchback 104, remain in place and allow the sheet 108 to be held high above the user's head. While FIG. 7 shows the bottom edge of the sheet 108 not reaching the ground, in many embodiments the sheet 108 provided will extend seven feet or more in length or height and will hence touch the ground or be near the ground.

In an embodiment, a system for providing a temporary sheltered space in a public parking area is provided. The system comprises a contiguous first panel and second panel of fabric positioned vertically and attached to each other at a single point proximate an upper edge of the attached panels. The system also comprises a sport utility vehicle that supports the panels via attachment of upper corners of the attached panels to upper rear body areas of the vehicle. The system also comprises an automatic rear hatch of the vehicle holding an upper edge of the attached panels between the corners at a bottom end of the hatch that further receives a command to fully open. During opening, the system raises the edge of the contiguous panels at the bottom end of the hatch while the upper corners of the attached panels remain attached to the upper rear body areas and do not move. Based on raising the edge of the panels at the bottom edge of the hatch, the system forms a temporary sheltered space comprising the raised hatch as roof and the panels hanging vertically from the raised hatch as sides of the sheltered space.

The temporary sheltered space is formed by the upper far corners of the panels held to the body of the vehicle while the edge of the panels that is midway between the upper corners is raised by the opening of the hatch. The panels are one of square and rectangular and are side by side.

The first panel is positioned left of the second panel and an upper righthand corner of the first panel and an upper lefthand corner of the second panel are attached at the single point to form a single sheet. The upper corners of the panels are attached to the upper rear body areas of the vehicle by one of magnets, suction cups, and snaps.

A vertical area between the panels below the single point provides for entry to the temporary sheltered space. Weights positioned at bottom edges of the attached panels and additional magnets hold the vertically hanging panels in place and limit movement of the panels due at least to wind.

In another embodiment, a method for providing a temporary privacy shelter in public settings is provided. The method comprises a sport utility vehicle with automatic hatchback receiving attachment of a sheet of fabric, upper corners of the sheet attached to upper rear corner areas of the vehicle. The method also comprises the vehicle receiving attachment of an upper edge of the sheet to a center bottom end of the hatchback when in closed position, the upper edge of the sheet situated midway between the corners. The method also comprises the vehicle receiving an instruction to open the hatchback. The method also comprises the vehicle, based on receipt of the instruction, causing the hatchback to fully open, the opening action causing the upper edge of the sheet attached to the hatchback to be lifted while the upper corners of the sheet remain attached to the upper rear corner areas of the vehicle.

The action of the lifting of the upper edge of the sheet attached to the bottom end of the hatchback while the upper corners of the sheet remain in place creates a four-sided temporary shelter. Three sides of the shelter comprise hanging portions of the lifted sheet and a fourth side comprises a back area of the vehicle, now opened.

The upper corners of the sheet are at ends of a same upper edge of the sheet wherein a midpoint of the edge is attached to the center bottom end of the hatchback. The sheet exhibits an open portion between a left half of the sheet and a right half of the sheet, the open portion forming an entryway to the temporary shelter after the sheet has been lifted.

The upper corners of the sheet are attached to the upper rear corners of the vehicle via magnets. Weights are positioned at bottom edges of the sheet. Additional magnets hold the vertically hanging sheet in place and limiting movement of the sheet due at least to air movement.

In yet another embodiment, a method for providing a temporary clothes-changing area in a public environment is provided. The method comprises a vehicle receiving attachment of a first upper corner of a sheet of fabric to a first exterior of a first window of the vehicle. The method also comprises the vehicle receiving attachment of a second upper corner of the sheet to a second exterior of a second window of the vehicle, wherein the first window is associated with a first door of the vehicle and wherein the second window is associated with a second door of the vehicle, the second door behind the first door and the sheet of fabric hanging loosely from the two windows when their associated doors are in closed position. The method also comprises the vehicle receiving opening of the first door while the second door remains closed. The method also comprises the vehicle, based on the opening of the first door second door remaining closed, causing the sheet to discontinue hanging loosely, pull tight, and form a temporary clothes-changing area, the area comprising the opened area of the first door covered by the sheet.

The sheltered area is formed by the opened first door and the tightly pulled sheet, the sheet remaining attached both the first and second doors. The upper corners are alternatively attached to areas of the first and second doors not comprising windows and instead comprising door frames.

The sheet adheres to the windows via suction cups. The fabric comprises nylon or other synthetic material or non-synthetic material. Weights positioned at bottom edge of the sheet hold the vertically hanging sheet in place and limit movement of the sheet due at least to air movement.

What is claimed is:

1. A system for providing a temporary sheltered space in a public parking area, comprising:
a contiguous first panel and second panel of fabric positioned vertically and attached to each other at a single point proximate an upper horizontal edge of the attached panels;
a sport utility vehicle that supports the panels via attachment of far upper left corner and far upper right corner of the attached panels to upper rear body areas of the vehicle;
an automatic rear hatch of the vehicle holding the upper edge of the attached panels between the corners at a bottom end of the hatch, that further:
receives a command to fully open,
during opening, raises the edge of the contiguous panels at the bottom end of the hatch while the upper corners of the attached panels remain attached to the upper rear body areas and do not move,
based on raising the edge of the panels at the bottom end of the hatch, forms a temporary sheltered space comprising the raised hatch as roof and the panels hanging vertically from the raised hatch as sides of the sheltered space.

2. The system of claim 1, wherein the temporary sheltered space is formed by the upper far corners of the panels held to the body of the vehicle while the edge of the panels that is midway between the upper corners is raised by the opening of the hatch.

3. The system of claim 1, wherein the panels are one of square and rectangular and are side by side.

4. The system of claim 1, wherein the first panel is positioned left of the second panel and wherein an upper righthand corner of the first panel and an upper lefthand corner of the second panel are attached at the single point to form a single sheet.

5. The system of claim 1, wherein the upper corners of the panels are attached to the upper rear body areas of the vehicle by one of magnets, suction cups, and snaps.

6. The system of claim 1, wherein a vertical area between the panels below the single point provides for entry to the temporary sheltered space.

7. The system of claim 1, wherein weights positioned at bottom edges of the attached panels and wherein additional magnets hold the vertically hanging panels in place and limit movement of the panels due at least to wind.

8. A method for providing a temporary privacy shelter in public settings, comprising
a sport utility vehicle with automatic hatchback receiving attachment of a sheet of fabric, upper corners of the sheet attached to upper rear corner areas of the vehicle;
the vehicle receiving attachment of an upper edge of the sheet to a center bottom end of the hatchback when in closed position, the upper edge of the sheet situated midway between the corners;
the vehicle receiving an instruction to open the hatchback; and
the vehicle, based on receipt of the instruction, causing the hatchback to fully open, the opening action causing the upper edge of the sheet attached to the hatchback to be lifted while the upper corners of the sheet remain attached to the upper rear corner areas of the vehicle.

9. The method of claim 8, further comprising the lifting of the upper edge of the sheet attached to the bottom end of the hatchback while the upper corners of the sheet remain in place creating a four-sided temporary shelter.

10. The method of claim 9, further comprising three sides of the shelter comprising hanging portions of the lifted sheet and a fourth side comprising a back area of the vehicle, now opened

11. The method of claim 8, wherein the upper corners of the sheet are at ends of a same upper edge of the sheet wherein a midpoint of the edge is attached to the center bottom end of the hatchback

12. The method of claim 8, further comprising the sheet exhibiting an open portion between a left half of the sheet and a right half of the sheet, the open portion forming an entryway to the temporary shelter after the sheet has been lifted.

13. The method of claim 8, wherein the upper corners of the sheet are attached to the upper rear corners of the vehicle via magnets.

14. The method of claim 8, further comprising weights positioned at bottom edges of the sheet and additional magnets holding the vertically hanging sheet in place and limiting movement of the sheet due at least to air movement.

15. A method for providing a temporary clothes-changing area in a public environment, comprising:
a vehicle receiving attachment of a first upper corner of a vertically positioned sheet of fabric to a first exterior of a first window of the vehicle
the vehicle receiving attachment of a second upper corner of the sheet to a second exterior of a second window of the vehicle, wherein the first window is associated with a first door of the vehicle and wherein the second window is associated with a second door of the vehicle, the second door behind the first door and the sheet of fabric hanging loosely from the two windows when their associated doors are in closed position;
the vehicle receiving opening of the first door while the second door remains closed;
the vehicle, based on the opening of the first door second door remaining closed, causing the sheet to discontinue hanging loosely, to pull tight, and to form a temporary clothes-changing area, the area comprising an opened area of the first door covered by the sheet.

16. The method of claim 15, wherein the sheltered area is formed by the opened first door and the tightly pulled sheet, the sheet remaining attached both the first and second doors.

17. The method of claim 15, further comprising the upper corners alternatively attached to areas of the first and second doors not comprising windows and instead comprising door frames.

18. The method of claim 15, further comprising the sheet adhering to the windows via suction cups.

19. The method of claim 15, further comprising the fabric comprising nylon.

20. The method of claim 15, further comprising weights positioned at bottom edge of the sheet holding the vertically hanging sheet in place and limiting movement of the sheet due at least to air movement.
